(19) United States
(12) Patent Application Publication
(10) Pub. No.: US 2022/0330726 A1
(43) Pub. Date: Oct. 20, 2022

(54) Personal Protection Devices

(71) Applicant: T.M. Shea Products, Inc., Troy, MI (US)

(72) Inventor: Thomas M. SHEA, Troy, MI (US)

(21) Appl. No.: 17/724,223

(22) Filed: Apr. 19, 2022

Related U.S. Application Data
(60) Provisional application No. 63/176,918, filed on Apr. 20, 2021.

(51) Int. Cl. A47F 9/04; E05F 11/54

(52) U.S. Cl. CPC A47F 9/04; E05F 11/54; A47F 2009/041

(57) ABSTRACT

A personal protection barrier includes at least panel, a plurality of support members, and a plurality of connection elements. The plurality of connection elements connect the at least one panel to the plurality of support members in a manner that allows the at least one panel to be vertically adjusted relative to the plurality of support members.

### CROSS-REFERENCE TO RELATED APPLICATIONS

This application claims the benefit of U.S. Provisional Application No. 63/176,918, filed on Apr. 20, 2021. The entire disclosure of the application referenced above is incorporated herein by reference.

### FIELD

The present teachings generally relate to personal protection devices for reducing or eliminating the transmission of viruses or other contagions.

### DISCUSSION

The recent COVID-19 pandemic has increased a demand for products that reduce the transmission of contagions between humans. In this regard, it remains both desirable and necessary for people to frequent retails and other areas in which encounters with other people occur. In addition to social distancing, it is desirable to provide personal protection devices that shield people from one another so as to reduce contact and reduce the exchange of exhaled breath or other body fluids. It is also desirable to provide devices for opening doors that do not require hand opening and are readily retrofitted to various types of existing doors.

### SUMMARY

An example of a personal protection barrier in accordance with the present teachings includes at least panel, a plurality of support members, and a plurality of connection elements. The plurality of connection elements connect the at least one panel to the plurality of support members in a manner that allows the at least one panel to be vertically adjusted relative to the plurality of support members.

Another example of a personal protection barrier in accordance with the present teachings includes at least two panels, a plurality of support members, a plurality of connection elements, and at least one connector. The plurality of connection elements connect the at least two panels to the plurality of support members. The at least one connector connects the at least two panels to one another while allowing the at least two panels to be articulated relative to one another.

An example of a hands-free door opening device in accordance with the present teachings includes a planar mounting portion, a double-sided adhesive strip, a generally vertically extending portion, and an intermediate portion. The double-sided adhesive strip is configured to be attached to one side of the planar mounting portion and to attach the planar mounting portion to a door. The intermediate portion connects the generally vertically extending portion and the planar mounting portion to one another. The generally vertically extending portion is horizontally spaced from the planar mounting portion to define a gap therebetween for receiving a user's forearm for hands-free opening of the door.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present invention will become more fully understood from the detailed description and the accompanying drawings, wherein:

FIG. 1 is a perspective view of a counter guard in accordance with the present teachings, panels of the counter guard shown in a first position;

FIG. 2 is a perspective view of a portion of the counter guard of FIG. 1, the panel of the counter guard shown in a second position raised from the first position;

FIG. 2A is a perspective view of the counter guard of FIG. 1, an arrow indicating vertical adjustability of the panels from a lowered position to a raised position;

FIGS. 3A and 3B are bottom perspective views of support members included in the counter guard of FIG. 1;

FIG. 4 is a perspective view of a portion of the counter guard of FIG. 1 including a connecting element enabling the vertical adjustability of the panels;

FIG. 5 is a perspective view of another counter guard in accordance with the present teachings, the counter guard including connectors that connect panels together;

FIG. 6 is a perspective view of one of the connectors of FIG. 6 when the panels are oriented relative to one another as shown in FIG. 6;

FIG. 7 is a perspective view of the counter guard of FIG. 6 with the panels positioned at a right angle relative to one another;

FIG. 8 is a perspective view of one of the connectors of FIG. 6 when the panels are oriented relative to one another as shown in FIG. 7;

FIG. 9 is a perspective view of the counter guard of FIG. 6 with the panels positioned at an acute angle relative to one another;

FIG. 10 is a perspective view of one of the connectors of FIG. 6 when the panels are oriented relative to one another as shown in FIG. 9;

FIG. 11 is a perspective view of a floor barrier in accordance with the present teachings;

FIG. 11A is a perspective view showing two of the floor barriers of FIG. 11 used together;

FIG. 12 is a perspective view of another floor barrier in accordance with the present teachings;

FIG. 13 is a perspective view of a hands-free door opening device in accordance with the present teachings;

FIG. 14 is a left side view of the hands-free door opening device of FIG. 13;

FIG. 15 is a right side view of the hands-free door opening device of FIG. 13;

FIG. 16 is a front side view of the hands-free door opening device of FIG. 13;

FIG. 17 is a rear side view of the hands-free door opening device of FIG. 13;

FIG. 18 is a top side view of the hands-free door opening device of FIG. 13;

FIG. 19 is a bottom side view of the hands-free door opening device of FIG. 13;

FIG. 20 is a perspective view of another hands-free door opening device in accordance with the present teachings;

FIG. 21 is a left side view of the hands-free door opening device of FIG. 20;

FIG. 22 is a right side view of the hands-free door opening device of FIG. 20;

FIG. 23 is a front side view of the hands-free door opening device of FIG. 20;

FIG. 24 is a rear side view of the hands-free door opening device of FIG. 20;

FIG. 25 is a top side view of the hands-free door opening device of FIG. 20;

FIG. 26 is a bottom side view of the hands-free door opening device of FIG. 20;

FIG. 27 is a perspective view of another hands-free door opening device in accordance with the present teachings;

FIG. 28 is a left side view of the hands-free door opening device of FIG. 27;

FIG. 29 is a right side view of the hands-free door opening device of FIG. 27;

FIG. 30 is a front side view of the hands-free door opening device of FIG. 27;

FIG. 31 is a rear side view of the hands-free door opening device of FIG. 27;

FIG. 32 is a top side view of the hands-free door opening device of FIG. 27; and

FIG. 33 is a bottom side view of the hands-free door opening device of FIG. 27.

It will be understood that the various embodiments shown throughout the application are drawn to scale. Like reference characters have been used throughout the various views to identify like elements.

### DESCRIPTION OF VARIOUS ASPECTS

The following description is merely exemplary in nature and is in no way intended to limit the invention, its application, or uses.

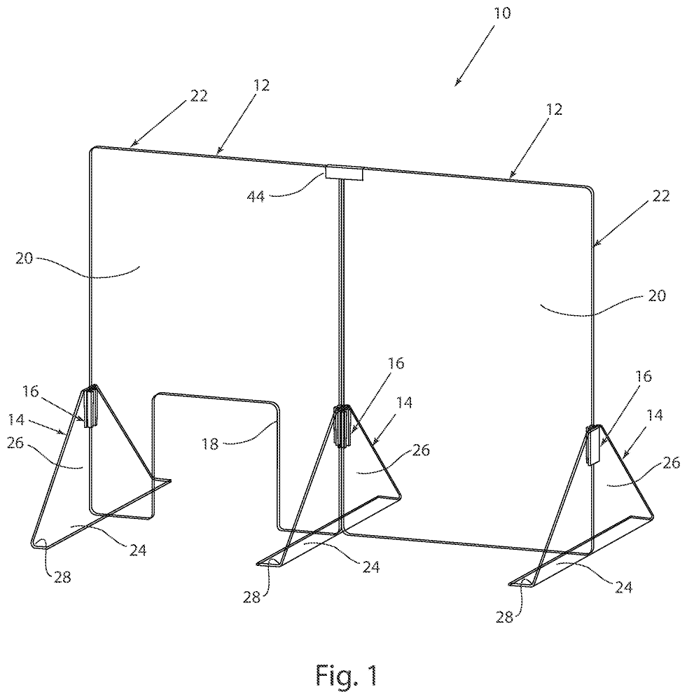

With initial reference to FIGS. 1. 2 and 2A, a counter guard 10 in accordance with the present teachings is illustrated. The counter guard 10 is generally shown to include at least one panel 12, a plurality of support members 14, and a corresponding plurality of connection elements 16. In the embodiment illustrated, the counter guard includes two panels 12. The panels 12 are vertically oriented. In other embodiments, the counter guard 10 may include a greater or lesser number of panels 12.

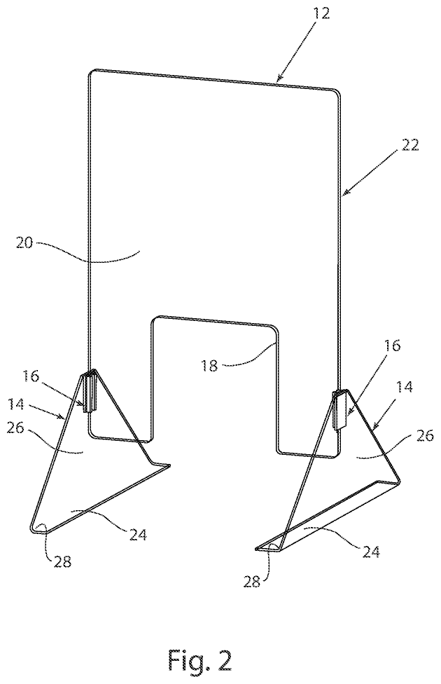

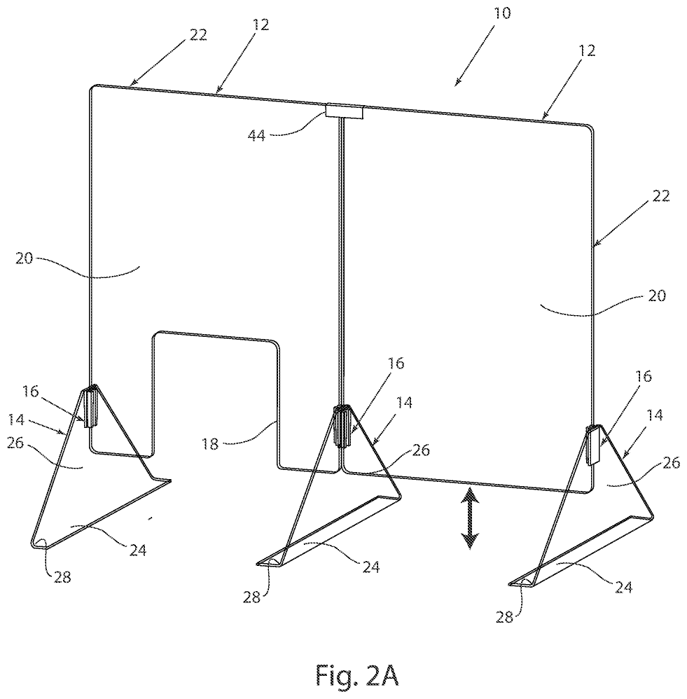

A first panel 12, shown on the left in FIGS. 1 and 2A and the only panel 12 shown in FIG. 2, is generally rectangular in shape and includes a rectangular opening 18 at a bottom thereof. A second panel 12, shown on the right in FIGS. 1 and 2A, is similarly rectangular in shape and is formed without any openings. The opening 18 of the first panel 12 may be used to pass items from one side of the panel 12 to the other side thereof while the panel 12 serves as a personal protection barrier.

Each panel 12 has a first side 20 and a second side 22 opposite of the first side 20. In the embodiment illustrated, the panels 12 may be constructed of a clear material such as acrylic. Other clear or opaque materials may be used within the scope of the present teachings.

In the embodiment illustrated in FIGS. 1 and 2A, the counter guard 10 is shown to include three support members 14 for supporting the first and second panels 12. The support members 14 may be constructed of acrylic. As shown, the support members 14 may be heat bent to include a horizontal portion 24, a vertical portion 26, and a bend 28 between the horizontal and vertical portions 24 and 26. The horizontal portion 24 may be generally rectangular in shape. The vertical portion 26 may be generally triangular in shape. The horizontal and vertical portions 24 and 26 are disposed on both the first and second sides 20 and 22 of the panel 12.

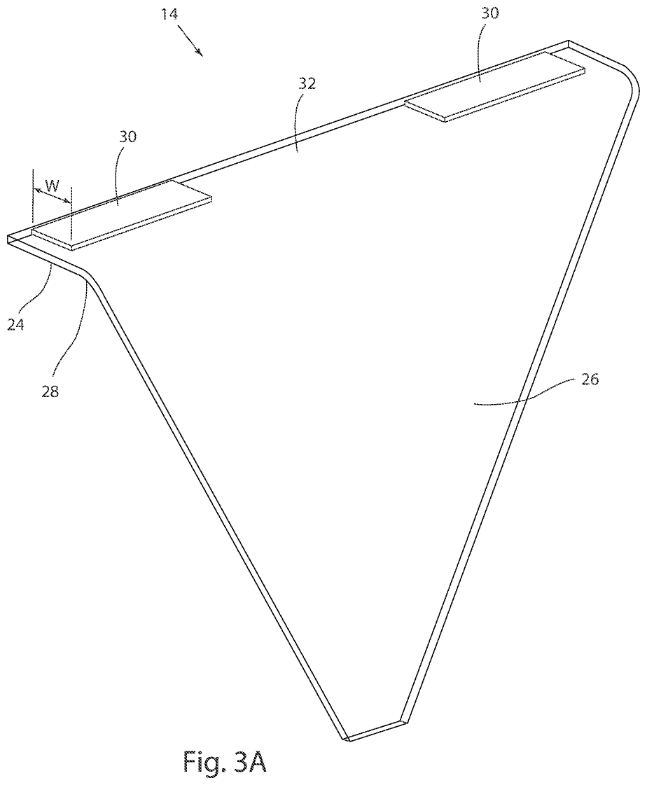

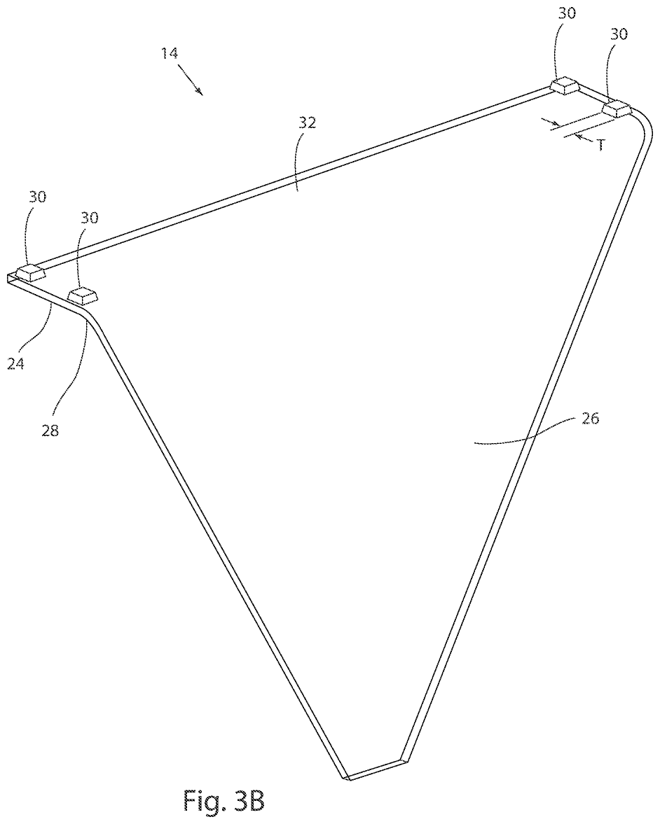

Turning briefly to FIGS. 3A and 3B, the counter guard 10 may include anti-slip members 30 attached to a bottom surface 32 of each support member 14 to inhibit slip between the support member 14 and a support surface on which the support member 14 rests (e.g., the top surface of a counter). In the embodiment illustrated in FIG. 3A, a pair of the anti-slip members 30 are attached to the bottom surface 32 of the support member 14, and each anti-slip member 30 is a double-sided adhesive strip. A width W of the adhesive strip may be within a range from 1 inch to 2 inches. One side of the adhesive strip adheres to the bottom surface 32 of the support member 14, and the other side of the adhesive strip adheres to the support surface. The adhesive strips enable semi-permanent positioning of the counter guard 10 on the support surface.

In the embodiment illustrated in FIG. 3A, four of the anti-slip members 30 are attached to the bottom surface 32 of the support member 14 adjacent to the corners of the horizontal portion 24 of the support member 14, and each anti-slip members 30 is a siliconized rubber pad. The rubber pads may be attached to the bottom surface 32 of the support member 14 using adhesive. A thickness T of each rubber pad may be about ¼ inch. The rubber pads inhibit slip between the support member 14 and the support surface while allowing the counter guard 10 to be moved or repositioned by, for example, picking up the counter guard 10 and setting it back down at a desired location on the support surface.

Turning again to FIGS. 1, 2, and 2A, the connection elements 16 connect the panels 12 to the vertical portions 26 of the support members 14 while allowing the panels 12 to be vertically adjusted relative to the support members 14. In this regard, the panels 12 are shown in FIG. 1 in a first or lower position and are shown in FIGS. 2 and 2A in a second or raised position. The panels 12 are secured to the connection elements 16 using a transition fit that enables the vertical adjustment of the panels 12 by allowing the panels to slide through the connection elements 16. In addition, the transition fit enables the panels 12 to be removed from the connection elements 16 and reinserted into the connection elements 16 by hand to, for example, rotate the panels 12 90 degrees from their vertical orientation (shown) to their horizontal orientation.

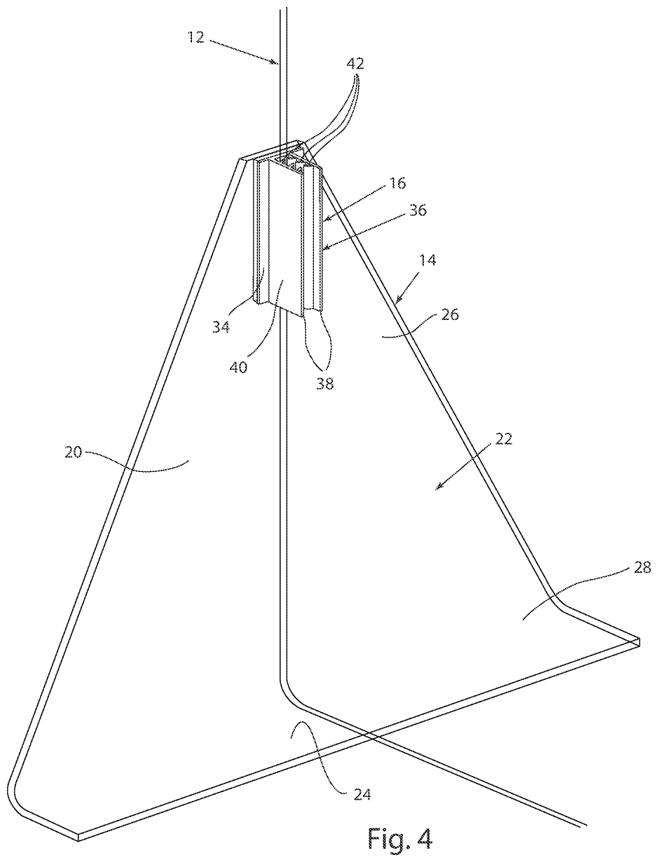

With additional reference to FIG. 4, each connection element 16 include a mounting portion 34 and a gripping portion 36. The mounting portion 34 may be glued or otherwise suitably attached to a corresponding one of the support members 14. The gripping portion 36 may include a pair of jaws 38 for gripping one of the panels 12. The jaws 38 may be formed by a U-shaped bracket 40 and a plurality of fins 42. The U-shaped bracket 40 defines a receptacle that receives an edge of one of the panels 12, and the fins 42 project into the receptacle.

The mounting portion 34 and the gripping portion 36, collectively, may be coextruded as a unitary body. The mounting portion 34 and the U-shaped bracket 40 may be made of a rigid material such as plastic, and the fins 42 may be made of a flexible material such as silicone. As a result, the fins 42 may flex as the edge of the panel 12 is inserted into the receptable, while the U-shaped bracket 40 may remain rigid to hold the fins 42 against the panel 12 and thereby hold the panel 12 in the receptacle. The fins 42 may be angled relative to the walls of the U-shaped bracket 40 in a direction toward the base of the U-shaped bracket 40 to make it easier to insert the edge of the panel 12 into the receptacle while inhibiting withdrawal of the edge therefrom.

The counter guard 10 may further include one or more connectors 44 constructed of acrylic or other suitable material. In the embodiment illustrated in FIGS. 1 and 2A, the counter guard 10 includes a single connector 44 connecting the first and second panels 12 to one another at the upper end of the counter guard 10.

As shown in FIGS. 1 and 2A, the first and second panels 12 are generally oriented in a common plane. It will be understood, however, that the connectors 44 provide for flexible connection between adjacent panels 12. In this regard, the panels 12 can be articulated relative to one another.

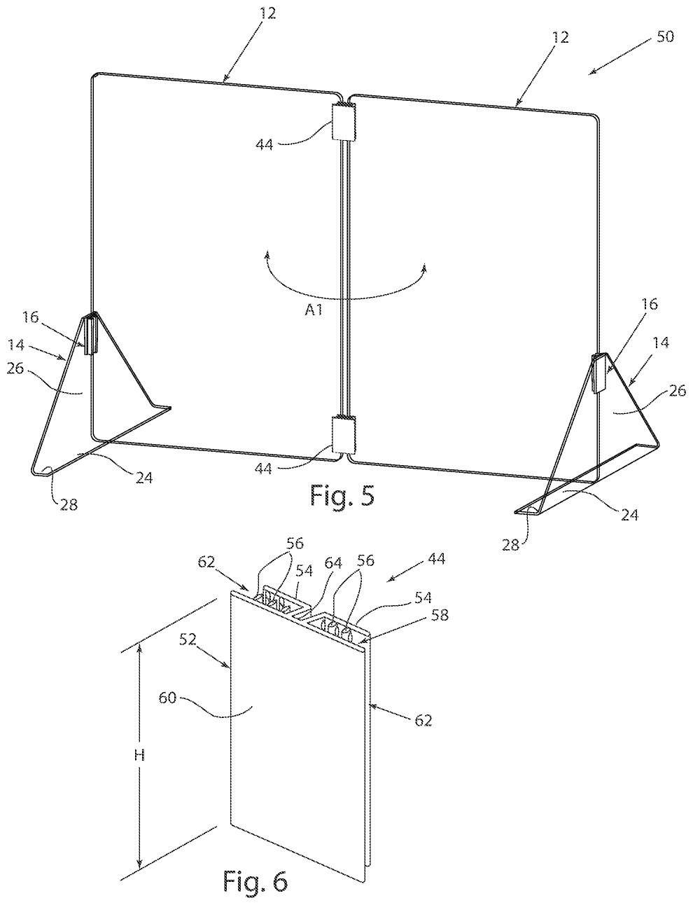

Turning to FIGS. 5 through 10, another counter guard 50 in accordance with the present teachings is illustrated. The counter guard 50 primarily differs from the counter guard 10 by including two connectors 44 instead of only one thereof and including two support members 14 instead of only three thereof. In addition, neither panel 12 of the color guard 50 defines the opening 18.

The connectors 44 connect the panels 12 to one another at both the upper and lower ends of the counter guard 50. The panels 12 are secured to the connectors 44 using a transition fit. As with the previous embodiment, the connectors 44 form a flexible connection between the panels 12 that enables articulating the panels 12 relative to one another. In FIG. 5, the panels 12 are oriented in a common plane such that an angle A1 between the panels 12 is a straight angle. FIG. 6 shows the shape of each connector 44 of the counter guard 50 when the panels 12 are oriented as shown in FIG. 5.

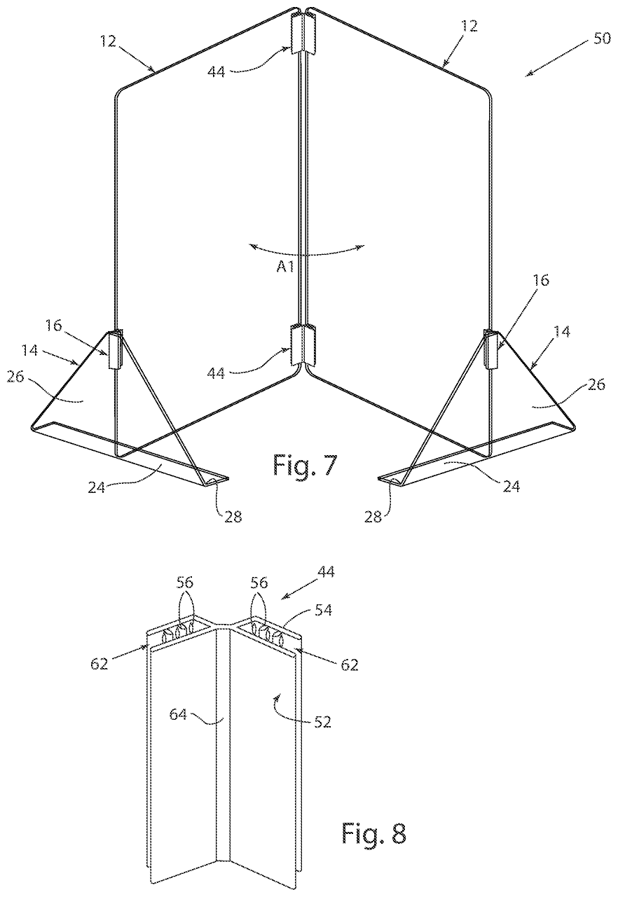

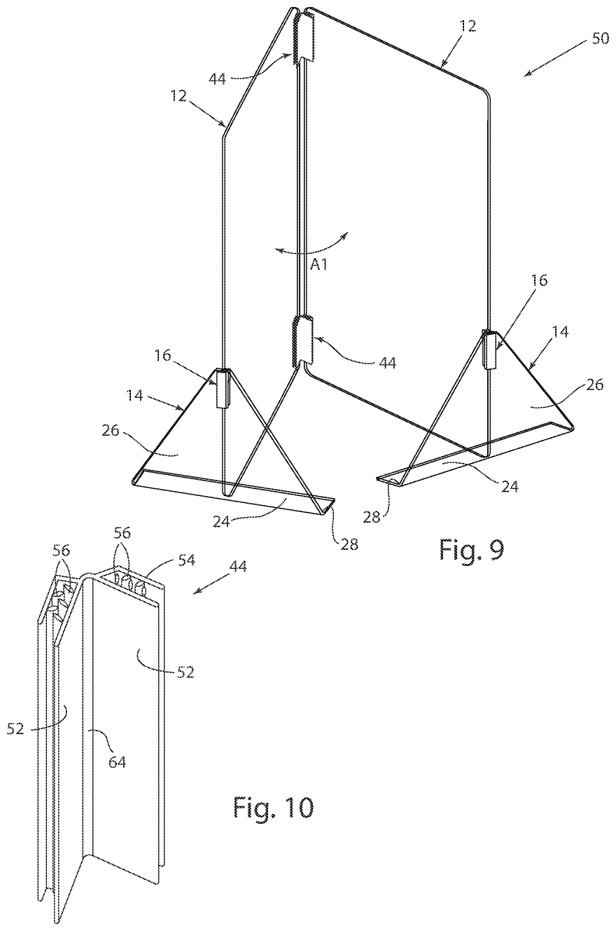

In FIG. 7, the angle A1 between the panels 12 is a right angle. FIG. 8 shows the shape of each connector 44 of the counter guard 50 when the panels 12 are oriented as shown in FIG. 7. In FIG. 9, the angle A1 between the panels 12 is an acute angle. FIG. 10 shows the shape of each connector 44 of the counter guard 50 when the panels 12 are oriented as shown in FIG. 9.

As shown in FIGS. 6, 8, and 10, each connector 44 includes a rectangular plate 52, a pair of L-shaped brackets 54, and a plurality of fins 56. A height H of each connector 44 may be about 3 inches. The rectangular plate 52 has a first side 58 and a second side 60 opposite of the first side 58. The L-shaped brackets 54 project from the first side 58 of the rectangular plate 52 and extend in opposite directions. Some of the fins 56 project from the first side 58 of the rectangular plate 52 toward one of the L-shaped brackets 54. The rest of the fins 56 project from the L-shaped brackets 54 toward the first side 58 of the rectangular plate 52.

The rectangular plate 52 and the L-shaped brackets 54 form receptacles 62 therebetween that receive the edges of the panels 12. One receptacle 62 receives the edge of one of the panels 12, and the other receptacle 62 receives the edge of the other panel 12. The fins 56 are disposed within the receptacles 62 and engage the panels 12 to hold the panels 12 in the receptacles 62. The fins 42 may be angled toward the base of the L-shaped brackets 54 to make it easier to insert the edge of the panel 12 into the receptacles 62 while inhibiting withdrawal of the edge therefrom.

The rectangular plate 52, the L-shaped brackets 54, and the fins 56, collectively, may be coextruded as a unitary body. The L-shaped brackets 54 and at least part of the rectangular plate 52 may be made of a first material, and the fins 56 may be made of a second material that is more flexible than the first material. For example, the first material may be plastic, and the second material may be silicone. As a result, the fins 56 may flex as the edge of the panel 12 is inserted into the receptable 62, while the rectangular plate 52 and the L-shaped brackets 54 may remain rigid to hold the fins 42 firmly against the panel 12 and thereby hold the panel 12 in the receptacle 62.

A portion 64 of the rectangular plate 52 disposed between the L-shaped brackets 54 forms a living hinge between the receptacles 62, and therefore each connector 44 forms a living hinge between the panels 12. While the first material of the rectangular plate 52 may be sufficiently rigid to maintain its shape as the edges of the panels 12 are inserted into the receptacles, the first material may be sufficiently flexible for the portion 64 of the rectangular plate 52 to form a living hinge. In various implementations, the thickness of the portion 64 of the rectangular plate 52 may be less than the thickness of the rest of the rectangular plate 52 so that the rectangular plate 52 bends along the portion 64 when the panels 12 are articulated relative to one another. Additionally or alternatively, the portion 64 of the rectangular plate 52 may be made of the second material, and the remainder of the rectangular plate 52 may be made of the first material.

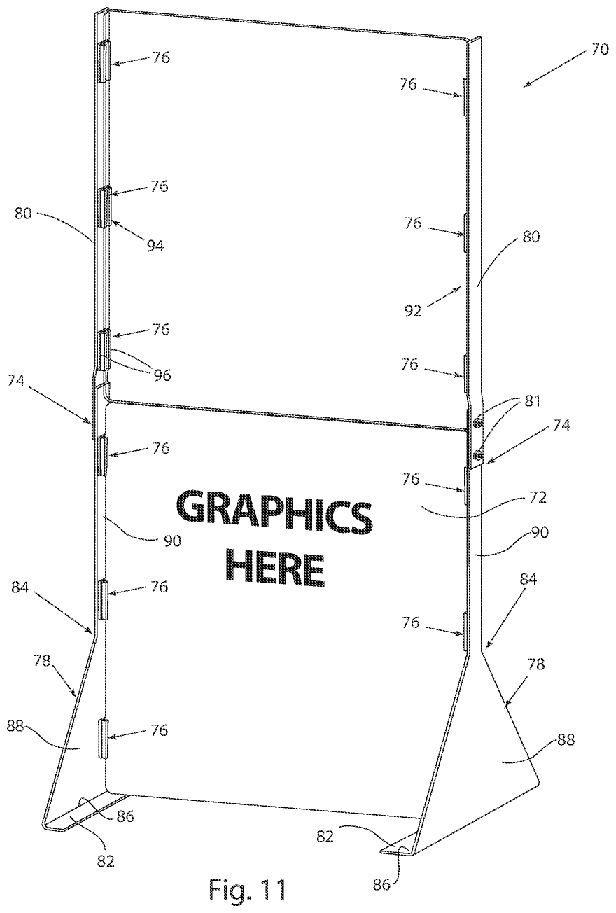

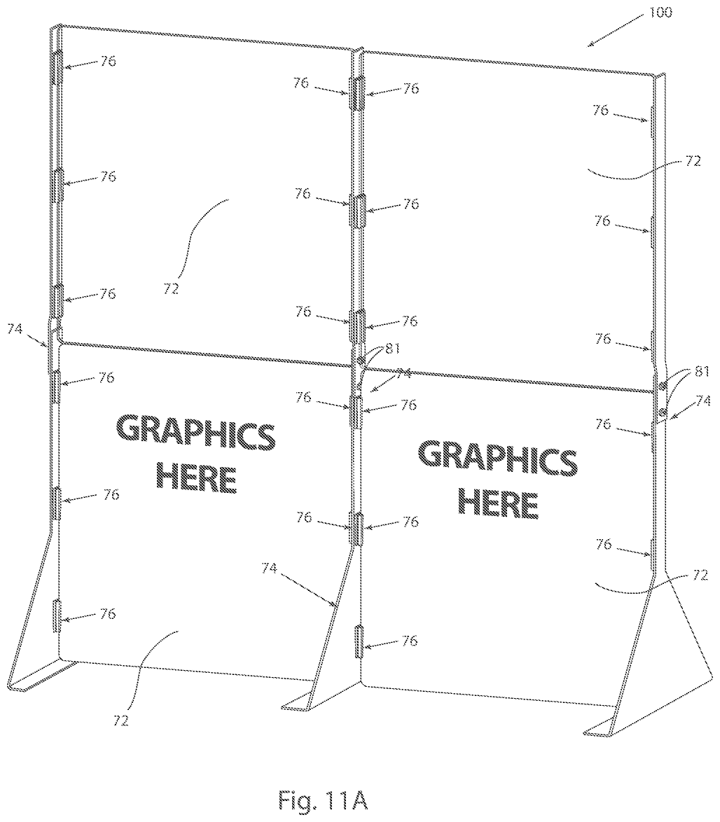

Turning to FIG. 11, a floor barrier 70 in accordance with the present teachings is illustrated. The floor barrier 70 is generally shown to include at least one panel 72, a plurality of support members 74, and a corresponding plurality of connection elements 76. In the embodiment illustrated, the floor barrier 70 includes two panels 72 that are vertically oriented. In other embodiments, the floor barrier 70 may include a greater or lesser number of panels 72.

In the embodiment illustrated, the panels 72 may be conducted of a clear material such as acrylic. In certain applications, one or more of the panels 72 may be constructed of corrugated plastic or printed UltraBoard® for privacy, advertising, and/or branding. For example, the lower panel 72 of FIG. 2 may be constructed of a non-clear material. This non-clear material may simply provide privacy or may additionally or alternatively be provided with branding or other advertising.

In the embodiment illustrated, the floor barrier 70 is shown to include two support members 74 for supporting the panels 72. The support members 74 may be constructed of acrylic. As shown, the support members 74 are shown to include lower portions 78 and upper portions 80 connected with fasteners 81. The lower portions 78 may be heat bent to include a horizontal portion 82, a vertical portion 84, and a bend 86 therebetween. The horizontal portion 82 may be generally rectangular in shape. The vertical portion 84 may include a triangular portion 88 and a rectangular portion 90.

The connection elements 76 adjustably connect the panels 72 with the support members 74. The connection elements 76 may include a mounting portion 92 and a gripping portion 94. The mounting portions 92 may be glued or otherwise suitably attached to a corresponding one of the support members 74. The gripping portion 94 may include a pair of jaws 96 for gripping one of the panels 72. The connection elements 76 of the floor barrier 70 may be similar or identical to the connection elements 16 of the counter guard 10.

Turning to FIG. 11A, another floor barrier 100 in accordance with the present teachings is illustrated. The floor barrier 100 of FIG. 11A primarily differs from the floor barrier 70 of FIG. 11 by including four of the panels 72 instead of only two thereof, including three of the support members 74 instead of only two thereof, and including a greater number of connection elements 76. In various implementations, instead of including the middle support member 74 and the connection elements 76 attached thereto, the floor barrier 100 may include the connectors 44 that connect the left and right panels 12 to one another while forming a hinge therebetween as in the counter guard 50 of FIGS. 5 through 10.

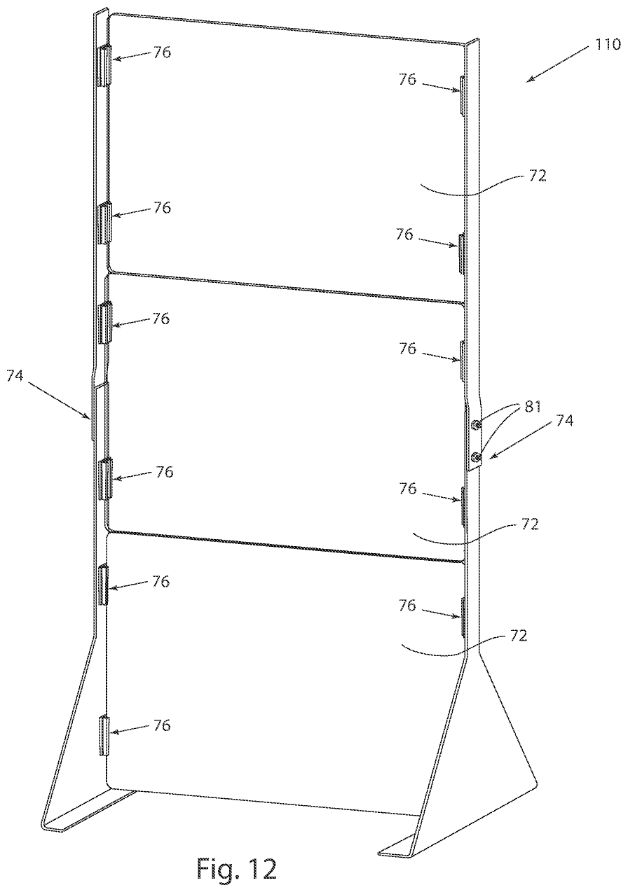

Turning to FIG. 12, another floor barrier 110 in accordance with the present teachings is illustrated. The floor barrier 110 of FIG. 12 primarily differs from the floor barrier 70 of FIG. 3 by incorporating three of the panels 12 instead of only two thereof.

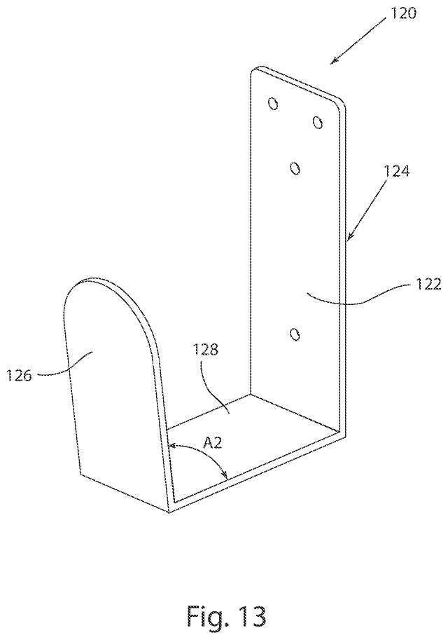

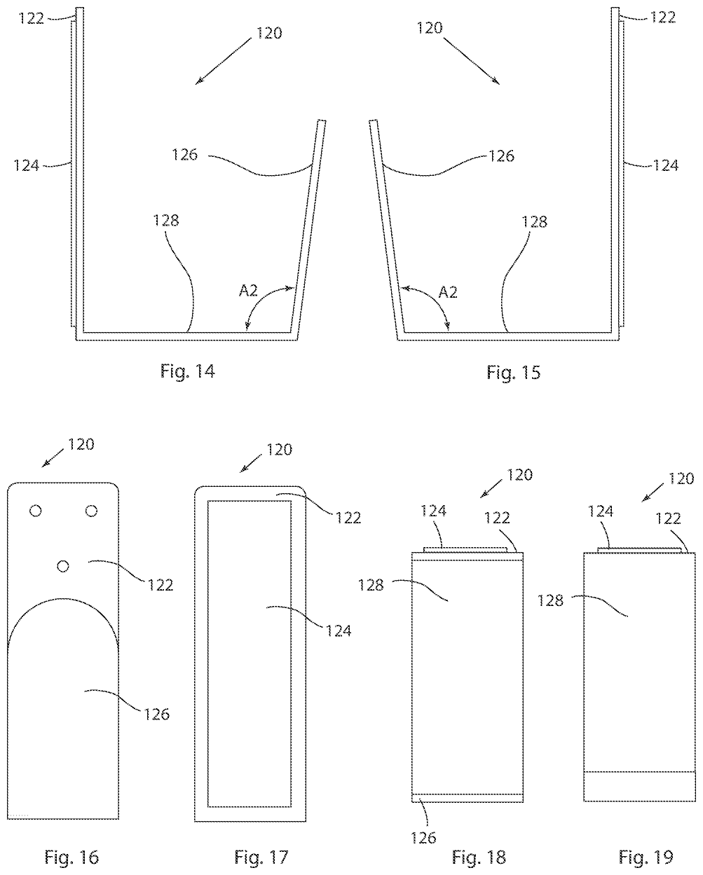

Turning to FIGS. 13 through 19, a hands-free door opening device 120 in accordance with the present teachings is illustrated. The door opening device 120 may be constructed of metal, plastic or other suitable material. In the embodiment illustrated, the door opening device 120 is constructed of a metal.

The door opening device 120 may include a planar mounting portion 122 for attachment to a door. The planar mounting portion 122 may be secured to the door using a double-sided adhesive strip 124. One side of the adhesive strip 124 is attached to the backside of the planar mounting portion 122 and the other side of the adhesive strip 124 is configured to be attached to a door. In this way, the adhesive strip 124 is configured to attach the planar mounting portion 122 to the door. In this manner, the door opening device 120 may be quickly and easily attached to a door without any modifications to the door. In other applications, however, the door opening device 120 may be mounting with screws or suction cups, for example.

The door opening device 120 is shown to further include a first generally vertically extending portion 126 and an intermediate portion 128 connecting the first generally vertically extending portion 126 and the planar mounting portion 122. In the embodiment illustrated, the first generally vertically extending portion 126 extends upwardly from the intermediate portion 128. An obtuse angle A2 may be defined between the first generally vertically extending portion 126 and the intermediate portion 128. The obtuse angle A2 may be between 90 and 120 degrees, for example.

The first generally vertically extending portion 126 is horizontally spaced from the planar mounting portion 122 to define a gap therebetween for receiving a user's forearm, for example. In this manner, the user may open an associated door in a hands-free manner.

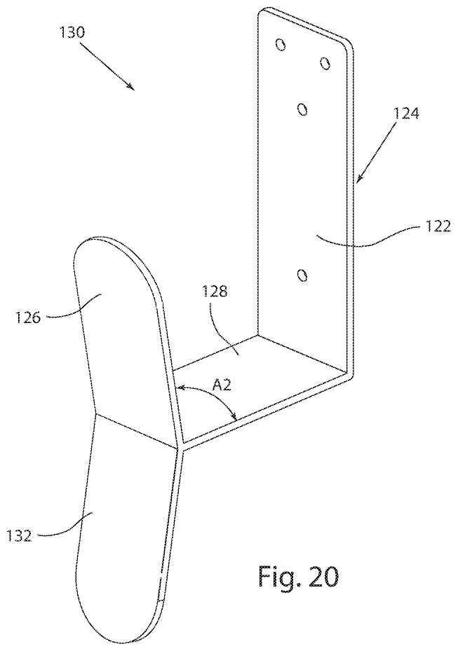

Turning to FIGS. 20 through 26, another a hands-free door opening device 130 in accordance with the present teachings is illustrated. The hands-free door opening device 130 of FIGS. 20 through 26 primarily differs from the hands-free door opening device 120 of FIGS. 13 through 19 by incorporating a second generally vertically extending portion 132. This second generally vertically extending portion 132 extends downwardly from the intermediate portion 128 and defines a gap relative to the door for receiving a forearm of a user.

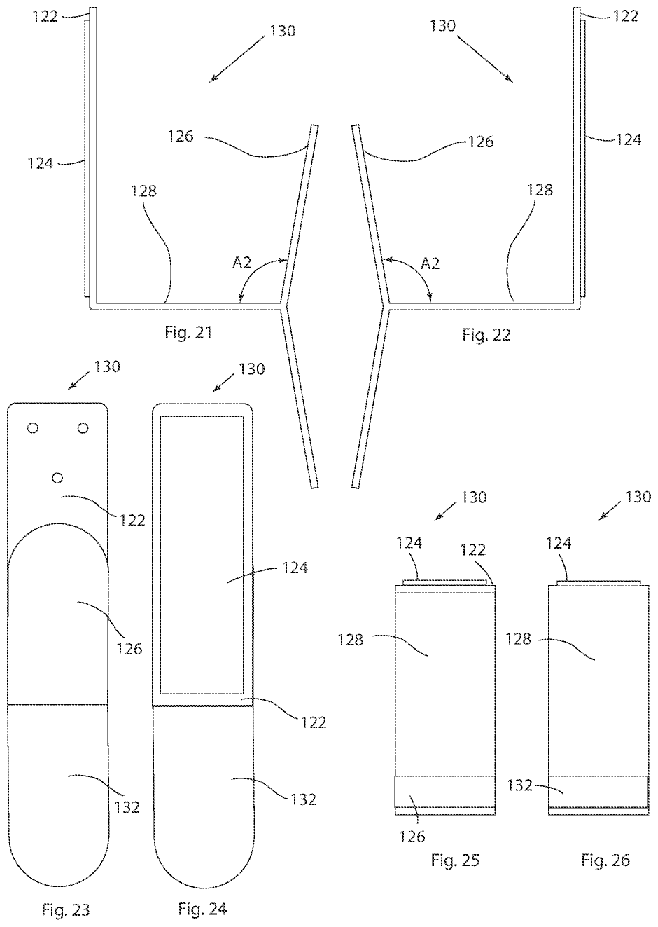

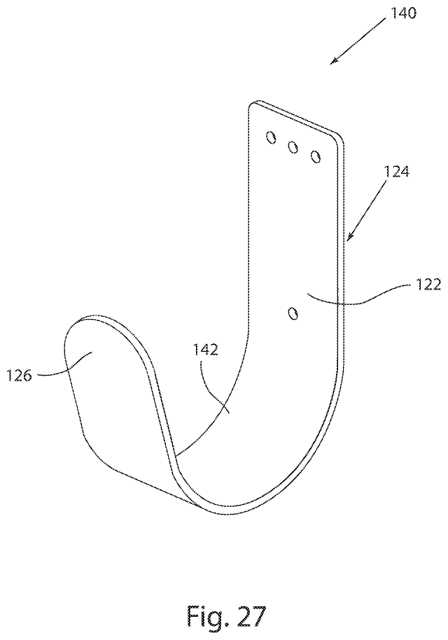

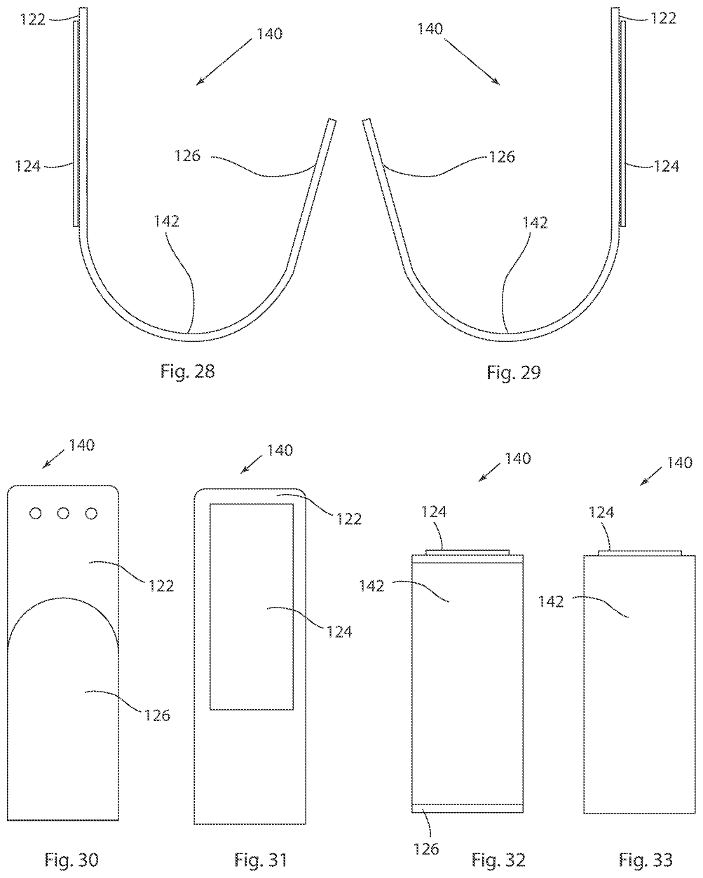

Turning to FIGS. 27 through 33, another a hands-free door opening device 140 in accordance with the present teachings is illustrated. The hands-free door opening device 140 of FIGS. 27 through 33 primarily differs from the hands-free door opening device 120 of FIGS. 13 through 19 by incorporating an arcuate intermediate portion 142 in place of the intermediate portion 128.

While specific examples and alternatives have been described in the specification and illustrated in the drawings, it will be understood by those skilled in the art that various further changes may be made by and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A personal protection barrier comprising:
at least one panel;
a plurality of support members; and
a plurality of connection elements connecting the at least one panel to the plurality of support members in a manner that allows the at least one panel to be vertically adjusted relative to the plurality of support members.

2. The personal protection barrier of claim 1 wherein:
each connecting element includes a mounting portion and a gripping portion;
the mounting portion is attached to one of the plurality of support members; and
the gripping portion includes a pair of jaws for gripping the at least one panel.

3. The personal protection barrier of claim 2 wherein the mounting portion is made of a rigid material, and at least part of the gripping portion is made of a flexible material.

4. The personal protection barrier of claim 2 wherein the mounting portion is made of plastic, and at least part of the gripping portion is made of silicone.

5. The personal protection barrier of claim 1 wherein the at least one panel is secured to the plurality of connection elements using a transition fit.

6. The personal protection barrier of claim 1 wherein the at least one panel is constructed of a clear material.

7. The personal protection barrier of claim 1 wherein:
each support member is angled includes a horizontal portion, a vertical portion;
and a bend between the horizontal and vertical portions;
the plurality of connection elements connect the at least one panel to vertical portions of the plurality of support members; and
each horizontal portion is disposed on both sides of the at least one panel.

8. The personal protection barrier of claim 1 further comprising at least one of an adhesive strip and a rubber pad attached to a bottom surface of each support member.

9. A personal protection barrier comprising:
at least two panels;
a plurality of support members;
a plurality of connection elements connecting the at least two panels to the plurality of support members; and
at least one connector connecting the at least two panels to one another while allowing the at least two panels to be articulated relative to one another.

10. The personal protection barrier of claim 9 wherein the at least one connector allows the at least two panels to articulated relative to one another from a first position in which the at least two panels are oriented in a common plane to a second position in which the at least two panels form an acute angle therebetween.

11. The personal protection barrier of claim 9 wherein the at least one connector forms a living hinge between the at least two panels.

12. The personal protection barrier of claim 9 wherein the at least one connector includes a rectangular plate, a pair of L-shaped brackets projecting from one side of the rectangular plate and extending in opposite directions, and a plurality of fins projecting from the L-shaped brackets toward the one side of the rectangular plate.

13. The personal protection barrier of claim 12 wherein the rectangular plate and the L-shaped brackets form receptacles therebetween for receiving the at least two panels, and the plurality of fins are disposed within the receptacles and engage the at least two panels to hold the at least two panels in the receptacles.

14. The personal protection barrier of claim 13 wherein a portion of the rectangular plate disposed between the L-shaped brackets forms a living hinge between the receptacles.

15. The personal protection barrier of claim 12 wherein the L-shaped brackets and at least part of the rectangular plate are made of a first material, and the plurality of fins are made of a second material that is more flexible than the first material.

16. The personal protection barrier of claim 12 wherein the plurality of fins and a portion of the rectangular plate disposed between the L-shaped brackets are made of silicone, and the L-shaped brackets and the remainder of the rectangular plate are made of plastic.

17. The personal protection barrier of claim 9 wherein the at least two panels secured to the at least one connector using a transition fit.

18. A hands-free door opening device comprising:
planar mounting portion;
a double-sided adhesive strip configured to be attached to one side of the planar mounting portion and to attach the planar mounting portion to a door;
a first generally vertically extending portion; and
an intermediate portion connecting the first generally vertically extending portion and the planar mounting portion to one another, wherein the first generally vertically extending portion is horizontally spaced from the planar mounting portion to define a gap therebetween for receiving a user's forearm for hands-free opening of the door.

19. The hands-free door opening device of claim 18 further comprising a second generally vertical extending portion, wherein the first generally vertical extending portion extends upwardly from the intermediate portion, the second generally vertical extending portion extends downwardly from the intermediate portion, and the first generally vertically extending portion is configured to define a gap relative to the door for receiving a user's forearm for hands-free opening of the door.

20. The hands-free door opening device of claim 18 wherein the intermediate portion has an arcuate shape.
